(19) United States
(12) Patent Application Publication
(10) Pub. No.: US 2026/0082277 A1
(43) Pub. Date: Mar. 19, 2026

(54) DATA STALL DETECTION AND MITIGATION

(71) Applicant: QUALCOMM Incorporated, San Diego, CA (US)

(72) Inventors: Rajashekar Chilla, San Diego, CA (US); Vijay Kumar Bolleni, San Diego, CA (US); Sri Sai Kandakatla, San Diego, CA (US); Sitaramanjaneyulu Kanamarlapudi, San Diego, CA (US)

(21) Appl. No.: 18/888,612

(22) Filed: Sep. 18, 2024

(51) Int. Cl. H04W 28/18

(52) U.S. Cl. CPC H04W 28/18; H04W 28/09

(57) ABSTRACT

In some aspects, an apparatus for wireless communication by a user equipment (UE) includes a processing system including one or more processors and one or more memories coupled to the one or more processors. The one or more processors include an application processor of the UE. The processing system is configured to receive, at the application processor from a modem of the UE, an indication of a data stall associated with the UE. The processing system is further configured to initiate, in accordance with the indication of the data stall, one or more operations associated with a data stall detection and mitigation procedure.

### TECHNICAL FIELD

Aspects of the present disclosure relate generally to wireless communication systems, and more particularly, to data stall detection and mitigation for wireless communication systems.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The systems, methods and devices of this disclosure each have several innovative aspects, no single one of which is solely responsible for the desirable attributes disclosed herein.

In some aspects, an apparatus for wireless communication by a user equipment (UE) includes a processing system including one or more processors and one or more memories coupled to the one or more processors. The one or more processors include an application processor of the UE. The processing system is configured to receive, at the application processor from a modem of the UE, an indication of a data stall associated with the UE. The processing system is further configured to initiate, in accordance with the indication of the data stall, one or more operations associated with a data stall detection and mitigation procedure.

In some further aspects, a method of operation of a user equipment (UE) includes receiving, at an application processor of the UE from a modem of the UE, an indication of a data stall associated with the UE. The method further includes initiating, in accordance with the indication of the data stall, one or more operations associated with a data stall detection and mitigation procedure.

In some additional aspects, a non-transitory computer-readable medium stores instructions executable by one or more processors of a user equipment (UE) to receive, at an application processor of the UE from a modem of the UE, an indication of a data stall associated with the UE. The instructions are further executable by the one or more processors to initiate, in accordance with the indication of the data stall, one or more operations associated with a data stall detection and mitigation procedure.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 is a block diagram illustrating an example wireless communication system that supports data stall detection and mitigation.

FIG. 2 is a block diagram illustrating examples of a base station and a UE that support data stall recovery and mitigation.

FIG. 3 is a block diagram illustrating an example wireless communication system that supports data stall detection and mitigation.

FIG. 4 is a flow diagram of an example of a method that supports data stall detection and mitigation.

FIG. 5 is a block diagram of an example of an application processor that supports data stall detection and mitigation.

FIG. 6 is a block diagram of an example of a UE that supports data stall detection and mitigation.

FIG. 7 is a flow diagram illustrating an example of a method that supports data stall detection and mitigation.

Like reference numbers and designations in the various drawings indicate like elements.

### DETAILED DESCRIPTION

During communication with a network node, a user equipment (UE) may experience a data stall in some cases. For example, issues including poor network scheduling, poor radio channel conditions, or other issues may cause the UE to experience a data stall. During a data stall, the UE may experience latency or “dropped” communications, resulting in a poor user experience. Some techniques for mitigating such data stalls may include performing network reselection to select from one network node to another network node. Such operations may be disruptive in some scenarios and may fail to resolve some data stalls, such as data stalls that arise from conditions associated with the UE (e.g., instead of network-related conditions).

In some aspects, a modem of a UE may detect whether a data stall is related to the modem or to an application processor (AP) of the UE. If the data stall is related to the modem, the UE may perform a network reselection procedure, which may include reselection from one network node to another network node. If the data stall is related to the AP, the modem may provide an indication of the data stall to the AP.

The AP may perform one or more operations of a data stall detection and mitigation procedure in accordance with the indication. In some examples, the one or more operations may include one or more of releasing a data interface between the modem and the AP, reestablishing the data interface, initiating a radio resource control (RRC) reset operation, releasing a packet data unit (PDU) session, reestablishing the PDU session, initiating a sub-system restart (SSR) of the modem, or initiating a reboot of the UE. Alternatively, or in addition, the one or more operations may include terminating an application executed by the AP. The application may be selected in accordance with one or more ranking criteria. In some examples, the one or more ranking criteria may include one or more of an idle time associated with the application, a memory utilization associated with the application, or a priority level associated with the application.

One or more features described herein may improve performance of a device within a wireless communication system. For example, by classifying data stalls into modem-related and AP-related data stalls, the UE may avoid performing unnecessary or counterproductive operations (e.g., by avoiding performing network-related mitigation operations, such as a reselection operation, when a data stall is attributable to operation of the UE instead of the network). As a result, performance may be improved as compared to some other techniques, such as techniques that involve automatically performing reselection without regard to whether the source of a data stall is network-related.

To further illustrate, one or more features described herein may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), 6th Generation (6G) networks, as well as other communication networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, 5G NR, or 6G technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

Wireless communication networks may include diverse deployments, diverse spectrum, and diverse services and devices that may be implemented using an OFDM-based unified, air interface. In some examples, a wireless communication network may be capable of scaling to provide coverage (1) to a massive Internet of things (IoTs) with an ultra-high density (e.g., ˜1 M nodes/km2), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km2), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In some wireless communication protocols, two initial operating bands may be identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mm Wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

Some devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in a wireless communication system, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

A scalable numerology may facilitate scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. A wireless communication system may also be implemented using a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

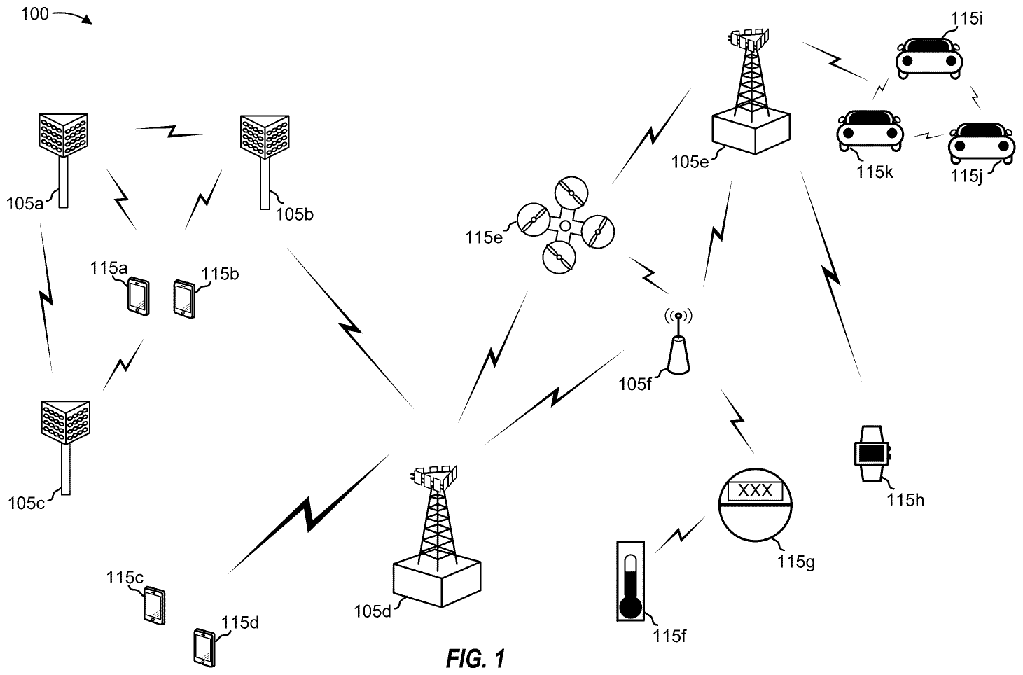

FIG. 1 is a block diagram illustrating an example wireless communication system that supports data stall detection and mitigation. The wireless communication system may include wireless network 100. Wireless network 100 may, for example, include a 5G wireless network, a 6G wireless network, or another wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such as UE 115e, which may correspond to a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105c.

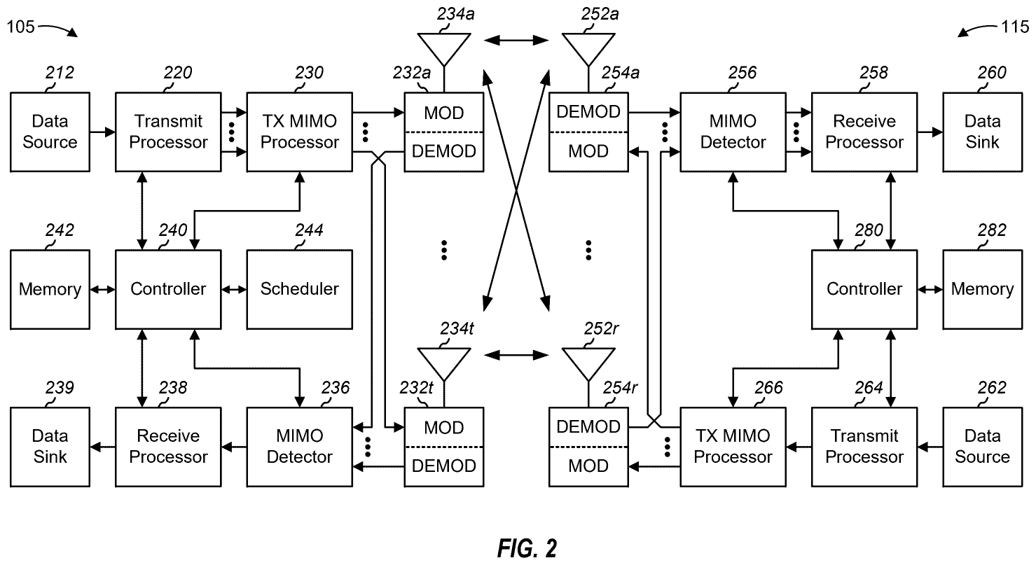

FIG. 2 is a block diagram illustrating examples of base station 105 and UE 115 that support data stall recovery and mitigation. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct one or more processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

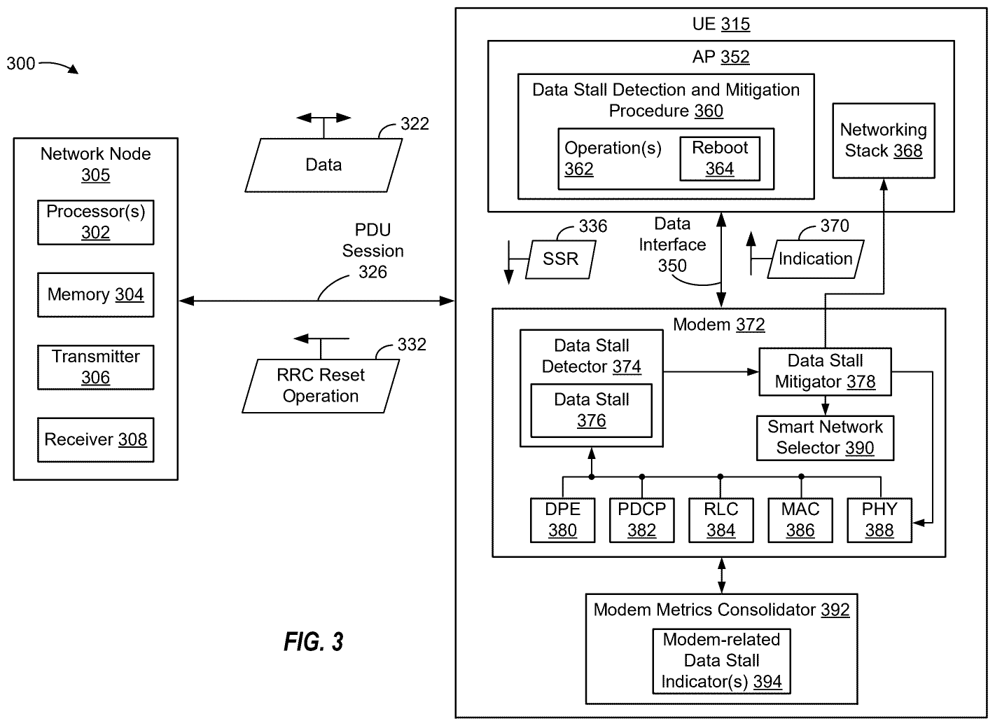

FIG. 3 is a block diagram illustrating an example wireless communication system 300 that supports data stall detection and mitigation. The wireless communication system 300 may include one or more UEs, such as a UE 315. In some examples, the UE 315 may correspond to the UE 115. The wireless communication system 300 may also include one or more network nodes, such as a network node 305. In some examples, the network node 305 may include or may correspond to the base station 105. To further illustrate, the network node 305 may include or may be implemented using one or more of a base station, a network controller, an integrated access and backhauling (IAB) node, a distributed unit (DU), a central unit (CU), or a remote/radio unit (RU) (which may also be referred to as a remote radio unit (RRU)), as illustrative examples.

The network node 305 may include one or more processors 302 (such as the controller 240), a memory 304 (such as the memory 242), a transmitter 306, and a receiver 308. The one or more processors 302 may be coupled to the memory 304, to the transmitter 306, and to the receiver 308. In some examples, the transmitter 306 and the receiver 308 may include one or more components described with reference to FIG. 2, such as one or more of the modulator/demodulators 232a-t, the MIMO detector 236, the receive processor 238, the transmit processor 220, or the TX MIMO processor 230. In some examples, the one or more processors 302 may be configured to individually or collectively perform one or more operations described herein.

The transmitter 306 may transmit reference signals, synchronization signals, control information, and data to one or more other devices, and the receiver 308 may receive reference signals, control information, and data from one or more other devices. For example, in some implementations, the transmitter 306 may transmit signaling, control information, and data to the UE 315, and the receiver 308 may receive signaling, control information, and data from the UE 315.

The UE 315 may include one or more processors, such as an application processor (AP) 352. In some examples, the AP 352 may include or may correspond to the controller 280 of FIG. 2, one or more other processors, or a combination thereof. The UE 315 may further include a modem 372. In some examples, the modem 372 may include one or more components described with reference to FIG. 2, such as one or more of the modulator/demodulators 254a-r, the MIMO detector 256, the receive processor 258, the transmit processor 264, or the TX MIMO processor 266. Further, in some examples, the AP 352 may be coupled to the memory 282 of FIG. 2, and the modem 372 may be coupled to the antennas 252a-r of FIG. 2. In some implementations, the modem 372 may include, or may be referred to as, a modem processor. In some implementations, the AP 352 may be coupled to the modem 372 via one or more interfaces, such as a data interface 350.

In some implementations, the UE 315 may include a modem metrics consolidator 392. The modem metrics consolidator 392 may be coupled to (or may be included in) the modem 372. The modem metrics consolidator 392 may monitor operation of the modem 372 to detect one or more indications of a data stall, such as by collecting one or more modem-related data stall indicators 394.

In some examples, the modem 372 may include, or may operate in accordance with, a data stall detector 374, a data stall mitigator 378 coupled to the data stall detector 374, and a smart network selector 390 coupled to the data stall mitigator 378. Further, in some examples, one or more of the data stall detector 374 and the data stall mitigator 378 may be coupled to or may be configured to access one or more other components or operating characteristics of the modem 372. To illustrate, the modem 372 may include, or may operate in accordance with, one or more of a data processing engine (DPE) 380, a packet data convergence protocol (PDCP) layer 382, a radio link control (RLC) layer 384, a medium access control (MAC) layer 386, and a physical (PHY) layer 388 (also referred to as an MLI layer). In some examples, the data stall detector 374 may be configured to access parameters associated with one or more of the DPE 380, the PDCP layer 382, the RLC layer 384, the MAC layer 386, or the PHY layer 388. In some examples, the data stall mitigator 378 may be configured to initiate one or more operations associated with the PHY layer 388, as described further below.

In some examples, the DPE 380 may perform one or more processing operations associated with wireless communications by the UE 315. To illustrate, the AP 352 (or another processor) may “offload” such processing operations to the DPE 380. In some implementations, the one or more processing operations may include packet routing, packet filtering, packet segmentation, packet reassembly, packet aggregation, data flow management, one or more other operations, or a combination thereof.

The modem 372 may transmit (or may control transmission of) reference signals, synchronization signals, control information, and data to one or more other devices. Further, the modem 372 may receive reference signals, control information, and data from one or more other devices. For example, in some implementations, the modem 372 may transmit signaling, control information, and data to the network node 305 and may receive signaling, control information, and data from the network node 305.

The wireless communication system 300 may use wireless communication channels, which may be specified by one or more wireless communication protocols, such as a 5G NR wireless communication protocol, a 6G wireless communication protocol, or another wireless communication protocol. To further illustrate, the network node 305 may communicate with the UE 315 using one or more downlink wireless communication channels (such as via one or more of a PDSCH or a PDCCH). The UE 315 may communicate with the network node 305 using one or more uplink wireless communication channels (such as via one or more of a PUSCH or a PUCCH). Alternatively, or in addition, the UE 315 may communicate with one or more other UEs, such as via a sidelink wireless communication channel.

During operation, the UE 315 may communicate with the network node 305, such as by communicating data 322 with the network node 305. Communicating the data 322 may include, for example, transmitting data 322 to the network node 305, receiving the data 322 (or other data) from the network node 305, or both. In some implementations, the UE 315 may establish a packet data unit (PDU) session 326 with the network node 305 and may communicate the data 322 with the network node 305 in connection with the PDU session 326.

In some cases, the UE 315 may detect a data stall 376. For example, in some implementations, the modem 372 may detect the data stall 376, such as by the modem 372 using the data stall detector 374. In some examples, the data stall 376 may include, or may be associated with, delay or failure associated with transmitting the data 322 to the network node 305. For example, failure of the UE 315 to receive HARQ feedback from the network node 305 within a threshold time interval after transmitting the data 322 may indicate the data stall 376. Alternatively, or in addition, the data stall 376 may include, or may be associated with, delay or failure associated with receiving the data 322 (or other data) from the network node 305. For example, failure of the UE 315 to receive the data 322 from the network node 305 within a threshold time interval after requesting the data 322 from the network node 305 may indicate the data stall 376.

In some examples, in accordance with detecting the data stall 376, the UE 315 may determine whether the data stall 376 corresponds to a modem-related data stall associated with the modem 372 or an AP related data stall associated with the AP 352. To illustrate, some data stalls may be associated with wireless noise or interference, which may degrade quality of communications between the UE 315 and the network node 305, and which may reduce ability of the modem 372 to receive or transmit data (such as the data 322). Further, some data stalls may result from poor network scheduling, such as scheduling of multiple wireless communications using the same wireless resources. In such examples, the data stall 376 may correspond to or may be referred to as a modem-related data stall. In some examples, in accordance with detecting such a data stall, the UE 315 may perform network reselection. Performing the network reselection may include, for example, initiating, by the smart network selector 390, reselection from the network node 305 to another network node or reselection from one network to another network.

In some other cases, some data stalls may be associated another condition, such as a condition associated with the AP 352. To illustrate, in some examples, a data stall may be resolved by terminating one or more applications executed by the AP 352. In such examples, the data stall 376 may correspond to or may be referred to as an AP-related data stall that is associated with the AP 352.

To further illustrate, in some examples, the modem 372 may classify the data stall 376, such as by determining whether the data stall 376 corresponds to one of a modem-related data stall or an AP-related data stall. In some examples, the data stall detector 374 may detect one or more conditions indicating that the data stall 376 is associated with the AP 352 instead of the modem 372. In some examples, the data stall detector 374 may detect the one or more conditions based on information generated or collected by the modem metrics consolidator 392, such as the one or more modem-related data stall indicators 394.

For example, detecting the one or more conditions may include determining that one or more first parameters associated with the modem 372 satisfy one or more modem related criteria. The one or more first parameters may include, for example, a channel quality metric, and the one or more first parameters may include that the channel quality metric (e.g., exceeds) a channel quality threshold. If the channel quality metric exceeds the channel quality threshold, the modem 372 may determine that the data stall 376 is (or is likely to be) an AP-related data stall. In some other examples, the modem 372 may determine that a data stall is (or is likely to be) a modem-related data stall if the channel quality metric fails to satisfy the channel quality threshold.

Alternatively, or in addition, detecting the one or more conditions may include determining that one or more second parameters associated with the AP 352 satisfy one or more AP-related criteria. To illustrate, in some examples, the modem 372 may detect that the data stall 376 results from failure of the AP 352 to provide data, a response, or other information to the modem 372. As an illustrative example, such a response may correspond to an acknowledgement (ACK) or a negative acknowledgement (NACK). To further illustrate, in connection with a session initiation protocol (SIP) session, the AP 352 may receive an acceptance message (e.g., a “200 OK” message) from a recipient and may be responsible for providing an ACK in response to the acceptance message. If the AP 352 fails to provide the ACK to the modem for transmission to the recipient, the data stall 376 may occur. In such examples, the one or more AP-related criteria may include failure of the AP 352 to provide the ACK (or other information) to the modem 372. In some further examples, the one or more AP-related criteria may include failure of the AP 352 to allocate, activate, deallocate, or deactivate one or more parameters or configurations, such as a packet data network (PDN). For example, a switch by the UE 315 from a default PDN (e.g., a “sub0” PDN) to another PDN (e.g., a “sub1” PDN) may involve deactivation of the default PDN by the AP 352. In such examples, the one or more AP-related criteria may include failure of the AP 352 to deactivate the default PDN.

In some additional examples, detecting the one or more conditions may include determining an exception associated with an aggregation or de-aggregation condition. To illustrate, in some examples, a drop may occur at the UE 315 as a result of a failure associated with a de-aggregation procedure that de-aggregates data. In some cases, the UE 315 may be unable to establish a data connection (e.g., the PDU session 326) or may experience delay in establishing the data connection as a result of one or more dropped packets, such as packets dropped as a result of the failure associated with the de-aggregation procedure.

In accordance with detecting that the data stall 376 corresponds to an AP-related data stall, the data stall detector 374 may provide an output to the data stall mitigator 378 indicating that the data stall 376 corresponds to an AP-related data stall. For example, the output may have one of a first value indicating that the data stall 376 corresponds to a modem-related data stall or a second value indicating that the data stall 376 corresponds to an AP-related data stall.

Further, in accordance with detecting that the data stall 376 corresponds to an AP-related data stall, the modem 372 may provide (e.g., via the data interface 350 or via another interface, such as a control interface between the AP 352 and the modem 372) an indication 370 to the AP 352 indicating the data stall 376. For example, in accordance with receiving the output from the data stall detector 374 indicating that the data stall 376 corresponds to an AP-related data stall, the data stall mitigator 378 may provide the indication 370 to the AP 352, such as to a networking stack 368 that may be associated with the AP 352.

In some examples, the indication 370 may include one or more recommended operations to be performed by the AP 352. As an illustrative example, if the modem 372 determines that the data stall 376 is caused (or likely caused) by failure of the AP 352 to provide an ACK (or other information) to the modem 372, the indication 370 may include a request for the ACK (or other information). As another example, if the modem 372 determines that the data stall 376 is caused (or likely caused) by failure of the AP 352 to deactivate a PDN, the indication 370 may include a request for the AP 352 to deactivate the PDN.

In some examples, the indication 370 may include a type or category associated with the data stall 376. To illustrate, in some implementations, the indication 370 may include multiple bits associated with multiple different respective types or categories. Each bit may have a value indicating whether the modem detects that the respective type or category to be associated with the data stall 376. As a non-limiting example, the indication may include a set of five bits each having a value indicating whether the modem 372 detects that the data stall 376 is associated with the DPE 380, the PDCP layer 382, the RLC layer 384, the MAC layer 386, and the PHY layer 388.

In accordance with receiving the indication 370 from the modem 372, the AP 352 may perform one or more operations 362 associated with a data stall detection and mitigation procedure 360. In some examples, the one or more operations 362 may include at least one operation indicated by the indication 370. Performing the one or more operations 362 associated with the data stall detection and mitigation procedure 360 may enable the UE 315 to resolve or mitigate the data stall 376 (e.g., where network reselection performed by the smart network selector 390 may be insufficient or ineffective to resolve or mitigate the data stall 376).

To illustrate, in some examples, performing the one or more operations 362 may include one or more of releasing the data interface 350 or reestablishing the data interface 350. For example, the AP 352 may provide a command to the modem 372 indicating that the modem 372 is to request that the network node 305 release the PDU session 326, reestablish the PDU session 326, or both.

Alternatively, or in addition, performing the one or more operations 362 may include initiating a radio resource control (RRC) reset operation 332. For example, the AP 352 may provide a command to the modem 372 indicating that the modem 372 is to request that the network node 305 reset an RRC connection between the network node 305 and the UE 315 (e.g., without performing a full release and reestablishment procedure). In some examples, the request may include or may correspond to an RRC connection reestablishment request message. In some examples, the request may indicate occurrence of the data stall 376. Further, in some examples, the UE 315 may receive an RRC connection reestablishment message from the network node 305 in accordance with the request. The RRC connection reestablishment message may include one or more updated configuration parameters for the UE 315 to resolve or mitigate the data stall 376.

Alternatively, or in addition, performing the one or more operations 362 may include releasing the PDU session 326, reestablishing the PDU session 326, or both. To illustrate, the AP 352 may provide a command to the modem 372 indicating that the modem 372 is to request that the network node 305 release and reestablish the PDU session 326. In some examples, the request may include or may correspond to a PDU session release request message. In some examples, the request may indicate occurrence of the data stall 376. Further, in some examples, the UE 315 may receive a session release command from the network node 305 in accordance with the request. After performing session release of the PDU session 326 in accordance with the session release command, the network node 305 and the UE 315 may perform a PDU session reestablishment procedure to reestablish the PDU session 326 (or to establish another PDU session), which may resolve or mitigate the data stall 376.

Alternatively, or in addition, performing the one or more operations 362 may include initiating a sub-system restart (SSR) 336. To illustrate, in some examples, initiating the SSR 336 may include providing, by the AP 352, a command to the modem 372 indicating that the modem 372 is to restart. The AP 352 may provide the command to the modem 372 via the data interface 350 or via another interface, such as a control interface between the AP 352 and the modem 372. In some examples, performing the SSR 336 may include restarting the modem 372 without restarting one or more other sub-systems of the UE 315, such as without restarting the AP 352.

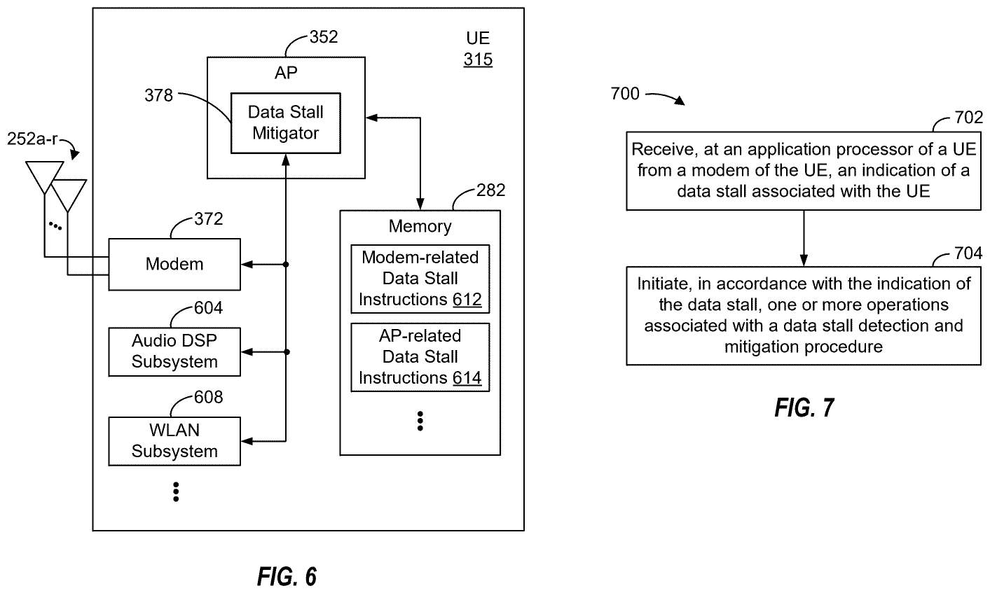

Alternatively, or in addition, performing the one or more operations 362 may include performing one or more memory management operations. To illustrate, in some cases, the data stall 376 may result from unavailability of a resource associated with the DPE 380 (e.g., a ring buffer associated with the DPE 380), a temporary memory pool reduction or exhaustion event, a memory “leakage” condition, a memory fragmentation condition, or a data allocation exception event. In some examples, the AP 352 may terminate one or more applications to mitigate such a condition. Some illustrative examples that may be associated with application termination are described further with reference to FIG. 6.

Alternatively, or in addition, performing the one or more operations 362 may include initiating a reboot 364 of the UE 315. For example, performing the one or more operations 362 may include requesting an operating system of the UE 315 to prepare for and execute the reboot 364. Preparing for the reboot 364 may include, for example, terminating one or more services or processes executed by the AP 352. After preparing for the reboot 364, the UE 315 may execute the reboot 364, such as by issuing a reboot instruction to hardware of the UE 315 and by activating a bootloader of the UE 315. After executing the reboot 364, the UE 315 may perform network reconnection, such as by reconnecting to the network node 305. In some examples, the AP 352 may initiate the reboot 364 as a “last resort,” such as after attempting to mitigate the data stall 376 using at least one operation of the one or more operations 362 and after detecting failure of the at least one operation to mitigate the data stall 376.

To further illustrate, Table 1 and Table 2 provide further examples in accordance with some aspects of the disclosure. In some examples, the UE 315 may detect one or more conditions of Table 1 and may perform one or more procedures of Table 2 in accordance with detecting the one or more conditions.

TABLE 1

| Condition | Criteria |
|---|---|
| Condition A | RX error(s), dropped RX communication(s), TX error(s), |
| | or dropped TX communication(s) > link_threshold |
| Condition B | Quantity of FC commands > FC_threshold |
| Condition C | Num_p_drop_pkts > drop_threshold \|\| |
| | num_p_excep_pkts > excep_threshold |
| Condition D | If Condition A && Condition B && Condition C |
| Condition E | If (not Condition A) && (not Condition B) && (not |
| | Condition C) |

TABLE 2

| Procedure | Criteria | Operation |
|---|---|---|
| Mitigation 1 | Condition A && not condition B | Release and bring |
| | && not condition C | up data interface |
| | | between modem and AP |
| Mitigation 2 | Condition B && not condition A | RRC Reset |
| | && not condition C | |
| Mitigation 3 | Condition C && not condition A | AP Release and bring |
| | && not condition B | up PDU session |
| Mitigation 4 | Condition D | AP trigger Modem SSR |
| Mitigation 5 | Condition E | AP trigger UE Reboot |

In the example of Table 1, detecting Condition A may include detecting that a quantity of one or more receive (RX) errors, a quantity of one or more dropped RX communications, a quantity of one or more transmit (TX) errors, or a quantity of one or more dropped TX communications exceeds a threshold. Further, detecting Condition B may include detecting that a quantity of flow control (FC) commands exceeds a threshold. In some examples, such FC commands may be issued by a component or service of the UE 315 (such as the data stall mitigator 378) to the DPE 380 to close an interface (e.g., a “pipe”) between the component or service and the DPE 380. In addition, detecting Condition C may include one or more of detecting that a quantity of dropped packets that exceeds a threshold or detecting that a quantity of exception packets exceeds a threshold. To illustrate, in some examples, a dropped packet may be detected based on a negative acknowledgement (NACK) received from the network node 305 or transmitted by the UE 315. In some examples, an exception packet may be generated based on a dropped packet or based on a NACK.

The example of Table 1 also illustrates one or more other conditions may be associated with multiple other conditions. For example, detecting Condition D may include detecting Condition A, Condition B, and Condition C. As another example, detecting Condition E may include detecting none of Condition A, Condition B, and Condition C. Other examples are also with the scope of the disclosure.

Table 2 indicates examples of operations that may be included in the one or more operations 362. To illustrate, in the example of Table 2, based on detecting Condition A (e.g., without detecting Conditions B and C), performing Mitigation 1 may include releasing and bringing up a data interface, such as the data interface 350. Table 2 also illustrates that performing Mitigation 2 may include initiating the RRC reset operation 332 based on detecting Condition B (e.g., without detecting Conditions A and C). Further, performing Mitigation 3 may include releasing and restoring the PDU session 326 based on detecting Condition C (e.g., without detecting Conditions A and B). In addition, performing Mitigation 4 may include triggering the SSR 336 based on detecting Condition D, and performing Mitigation 5 may include initiating the reboot 364 based on detecting Condition E. Other examples are also within the scope of the disclosure.

After performing the one or more operations 362, the UE 315 may verify whether the data stall 376 is mitigated or resolved. For example, the UE 315 may resume communication with the network node 305 (or with another network node). If the UE 315 determines that the data stall 376 is mitigated or resolved, the UE 315 may determine completion of the data stall detection and mitigation procedure 360. In some other examples, if the UE 315 determines that the data stall 376 is unmitigated or unresolved, the UE 315 may perform another operation, such as by sending the network node 305 an indication that connectivity of the UE 315 is limited, by presenting a user notification that connectivity of the UE 315 is limited, or both.

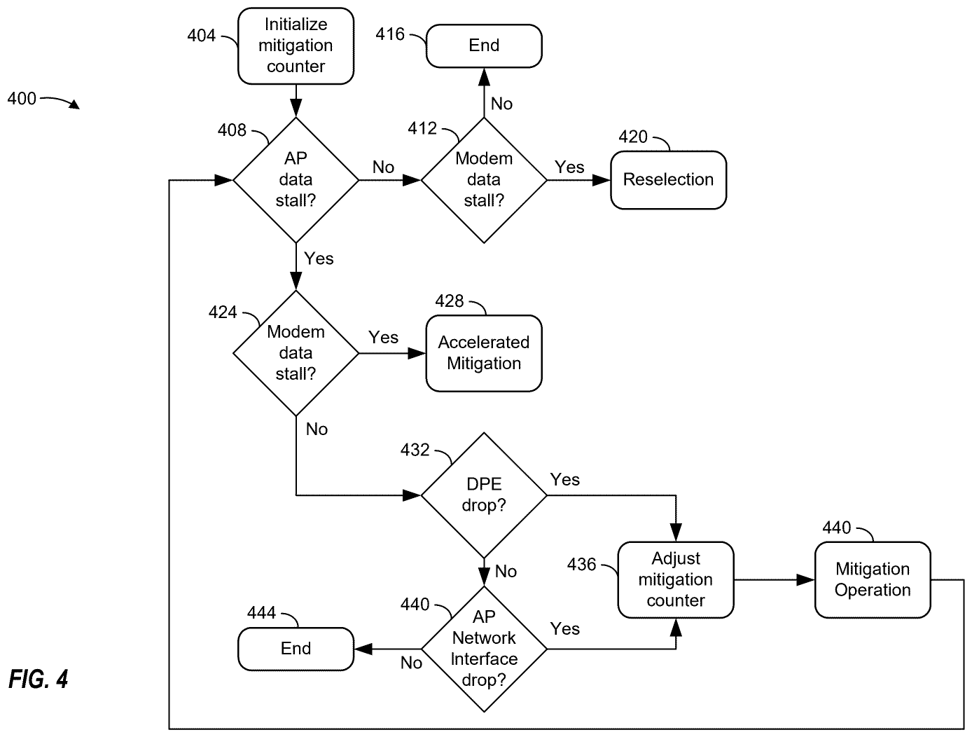

FIG. 4 is a flow diagram of an example of a method 400 that supports data stall detection and mitigation. In some examples, the method 400 may be performed by a UE, such as one or more of the UE 115 or the UE 315.

The method 400 may include initializing a mitigation counter, at 404. For example, the modem 372 may include a mitigation counter that stores a value. In some examples, the value may indicate a quantity of AP-related data stall events detected by the modem 372. The method 400 may further include determining whether an AP-related data stall is detected, at 412.

In some examples, if no AP-related data stall is detected (at 408), the method 400 may further include determining whether a modem-related data stall is detected, at 412. If a modem-related data stall is detected (at 412), the method 400 may further include performing reselection (e.g., by performing network reselection by the smart network selector 390), at 420. If no modem data stall is detected (at 412), the method 400 may terminate, at 416.

In some other examples, if an AP-related data stall is detected (at 408), the method 400 may further include determining whether a modem-related data stall is detected, at 424. If a modem-related data stall is detected (at 424), the method 400 may further include performing accelerated mitigation, at 428. For example, in some implementations, the UE 315 may perform both the data stall detection and mitigation procedure 360 and network reselection by the smart network selector 390.

If no modem-related data stall is detected (at 424), the method 400 may further include determining whether a first drop (e.g., an DPE drop associated with the DPE 380) is detected, at 432. For example, the AP 352 may query the modem 372 to determine whether the DPE 380 is associated with a drop condition, such as one or more dropped transmit packets, one or more dropped receive packets, or a combination thereof. If the first drop is detected (at 432), the method 400 may further include adjusting the mitigation counter, at 436. For example, adjusting the mitigation counter may include adjusting (e.g., increasing) a value indicated by the mitigation counter.

If no first drop is detected (at 432), the method 400 may further include determining whether a second drop (e.g., an application processor (AP) network interface drop) is detected, at 440. If no second drop is detected (at 440), the method 400 may terminate, at 444. If the second drop is detected (at 440), the method 400 may include adjusting the mitigation counter, at 436. For example, adjusting the mitigation counter may include adjusting (e.g., increasing) a value indicated by the mitigation counter.

The method 400 may further include performing a mitigation operation, at 440. For example, performing the mitigation operation may include performing any of the one or more operations 362 of FIG. 3. In some examples, the mitigation counter may be used in connection with the data stall detection and mitigation procedure 360. To illustrate, operations of the data stall detection and mitigation procedure 360 may be respectively associated with values of the mitigation counter, such as where a first operation may be performed based on a first value of the mitigation counter, and where a second operation may be performed based on a second value of the mitigation counter. The method 400 may continue, at 404.

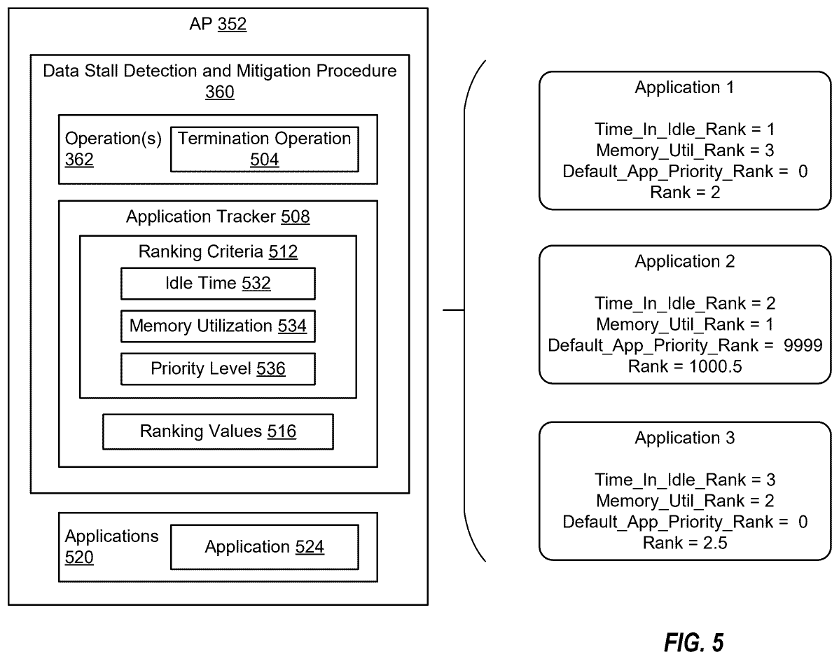

FIG. 5 is a block diagram of an example of an AP 352 that supports data stall detection and mitigation. In the example of FIG. 5, the AP 352 may execute applications 520. Further, the data stall detection and mitigation procedure 360 may be associated with an application tracker 508. In some examples, the application tracker 508 may select, from among the applications 520, an application 524 to be terminated via a termination operation 504 (e.g., to mitigate or reduce the data stall 376 of FIG. 3). In such examples, performing the one or more operations 362 may include terminating the application 524 via the termination operation 504.

To illustrate, in some examples, the application tracker 508 may determine ranking values 516 respectively associated with the applications 520. The ranking values 516 may indicate ranking of the applications 520 for the termination operation 504. For example, the ranking values 516 may include a first ranking of the application 524 and a second ranking of another application of the applications 520. The first ranking may indicate that the application 524 is preferred for the termination operation 504 relative to the other application.

In some examples, the application tracker 508 may determine the ranking values 516 in accordance with one or more ranking criteria 512. In some examples, the one or more ranking criteria 512 may include, for each application of the applications 520, one or more of an idle time 532 associated with the application, a memory utilization 534 associated with the application, or a priority level 536 associated with the application. The idle time 532 may indicate a duration of time since an application was active. The memory utilization 534 may indicate, for example, an amount of memory storage of a memory associated with an application, such as a quantity of bytes of the memory used by the application. In some examples, the memory may correspond to the memory 282. To further illustrate, Equation 1 illustrates an example that may be in accordance with the one or more ranking criteria 512:

$$AppRank = α * ( Time\_In \_Idle \_Rank ) + β * ( Memory\_Uti1 \_Rank ) + App\_Priority \_Rank . \qquad ( Equation l )$$

In Equation 1, “AppRank” may correspond to a ranking value of the ranking values 516 that is associated with an application of the applications 520. Further, “Time_In_Idle_Rank” may correspond to the idle time 532 of the application, “Memory_Util_Rank” may correspond to the memory utilization 534 of the application, and “App_Priority_Rank” may correspond to the priority level 536 of the application. Further, in some implementations, a and B may correspond to weighting values that may be used to weight the idle time 532 and the memory utilization 534, respectively. It is noted that the particular examples described with reference to FIG. 5 are illustrative and that other examples are also within the scope of the disclosure.

In some examples, performing the termination operation 504 may reduce or mitigate the data stall 376. For example, in some cases, the UE 315 may experience a temporary memory pool reduction or exhaustion event, which may be caused, for example, by a relatively large quantity of applications 520 being executed by the AP 352. By prioritizing one or more of the applications 520 for the termination operation 504 in accordance with the one or more ranking criteria 512, such events may be reduced or mitigated while also enabling more important applications of the applications 520 to remain active.

FIG. 6 is a block diagram of an example of a UE 315 that supports data stall detection and mitigation. In some examples, the UE 315 may include the AP 352 and the memory 282. Using the AP 352, the UE 315 may transmit and receive signals via the modem 372, which may be coupled to the antennas 252a-r.

In the example of FIG. 6, the AP 352 may include a data stall mitigator, such as the data stall mitigator 378. In some examples, the data stall mitigator 378 may be coupled to multiple subsystems of the UE 315 (alternatively or in addition to the modem 372). The data stall mitigator 378 may provide data stall mitigation to the multiple subsystems. For example, the multiple subsystems may include, alternatively in addition to the modem 372, one or more of an audio digital signal processor (DSP) subsystem 604 or a wireless local area network (WLAN) subsystem 608. Other examples are also within the scope of the disclosure.

The memory 282 may store instructions executable the AP 352 to initiate, perform, or control one or more operations described herein. For example, the memory 282 may store modem-related data stall instructions 612 executable by the AP 352 to detect that data stalls are related to the modem 372 and to reduce or mitigate such data stalls via network reselection by the smart network selector 390. As another example, the memory 282 may store AP-related data stall instructions 614 executable by the AP 352 to detect that data stalls are related to the AP 352 and to reduce or mitigate such data stalls via the data stall detection and mitigation procedure 360.

Although some examples may be described with reference to the UE 315 and the network node 305, other examples are also within the scope of the disclosure. For example, alternatively or in addition to perform data stall detection and mitigation at the UE 315, in some examples, one or more examples described herein may be performed by the network node 305 (e.g., to detect and mitigate a data stall). As another example, alternatively or in addition to performing data stall detection and mitigation in connection with communication with the network node 305, the UE 315 may perform data stall detection and mitigation in connection with communication with one or more other devices, such as another UE. The UE 315 may communicate with such one or more other devices via a sidelink communication channel, as an illustrative example. Other examples are also within the scope of the disclosure.

In some aspects, a device (such as the UE 115 or the UE 315) may include a processing system. The processing system may include one or more processors and one or more memories coupled to the one or more processors. To illustrate, in some examples, the one or more processors may include the AP 352, the modem 372, one or more other processors, or a combination thereof. In some examples, the one or more memories may include the memory 282, one or more other memories, or a combination thereof.

FIG. 7 is a flow diagram illustrating an example of a method 700 that supports data stall detection and mitigation. In some examples, the method 700 may be performed by a UE, such as the UE 115 or the UE 315.

The method 700 includes receiving, at an application processor of a UE from a modem of the UE, an indication of a data stall associated with the UE, at 702. For example, the AP 352 may receive the indication 370 of the data stall 376 from the modem 372.

The method 700 further includes initiating, in accordance with the indication of the data stall, one or more operations associated with a data stall detection and mitigation procedure, at 704. For example, in accordance with the indication 370 of the data stall 376, the UE 315 may initiate (or may perform) the one or more operations 362.

One or more features described herein may improve performance of a device within a wireless communication system. For example, by classifying data stalls into modem-related and AP-related data stalls, the UE 315 may avoid performing unnecessary or counterproductive operations (e.g., by avoiding performing network-related mitigation operations, such as a reselection operation, when a data stall is attributable to operation of the UE 315 instead of the network). As a result, performance may be improved as compared to some other techniques, such as techniques that involve automatically performing reselection without regard to whether the source of a data stall is network-related.

To further illustrate some aspects, in a first aspect, an apparatus for wireless communication by a user equipment (UE) includes a processing system including one or more processors and one or more memories coupled to the one or more processors. The one or more processors include an application processor of the UE. The processing system is configured to receive, at the application processor from a modem of the UE, an indication of a data stall associated with the UE. The processing system is further configured to initiate, in accordance with the indication of the data stall, one or more operations associated with a data stall detection and mitigation procedure.

In a second aspect, in combination with the first aspect, in accordance with the one or more operations, the processing system is further configured to release a data interface between the modem and the application processor, reestablish the data interface, initiate a radio resource control (RRC) reset operation, release a packet data unit (PDU) session associated with a network node, reestablish the PDU session, initiate a sub-system restart (SSR) associated with the modem, or initiate a reboot of the UE.

In a third aspect, in combination with one or more of the first aspect or the second aspect, in accordance with the one or more operations, the processing system is further configured to terminate a particular application executed by the application processor.

In a fourth aspect, in combination with one or more of the first aspect through the third aspect, the processing system is further configured to determine, in accordance with one or more ranking criteria, a plurality of ranking values respectively associated with a plurality of applications executed by the application processor. The plurality of applications includes the particular application, and the processing system is further configured to terminate the particular application in accordance with the plurality of ranking values.

In a fifth aspect, in combination with one or more of the first aspect through the fourth aspect, the one or more ranking criteria include, for each application of the plurality of applications, one or more of an idle time associated with the application, a memory utilization associated with the application, or a priority level associated with the application.

In a sixth aspect, in combination with one or more of the first aspect through the fifth aspect, the processing system is further configured to detect one or more conditions indicating that the data stall is associated with the application processor instead of the modem.

In a seventh aspect, in combination with one or more of the first aspect through the sixth aspect, the processing system is further configured to detect the one or more conditions in accordance with one or more first parameters associated with the modem satisfying one or more modem related criteria.

In an eighth aspect, in combination with one or more of the first aspect through the seventh aspect, the processing system is further configured to detect the one or more conditions in accordance with one or more second parameters associated with the application processor satisfying one or more application processor related criteria.

In a ninth aspect, a method of operation of a user equipment (UE) includes receiving, at an application processor of the UE from a modem of the UE, an indication of a data stall associated with the UE. The method further includes initiating, in accordance with the indication of the data stall, one or more operations associated with a data stall detection and mitigation procedure.

In a tenth aspect, in combination with the ninth aspect, the one or more operations include one or more of releasing a data interface between the modem and the application processor, reestablishing the data interface, initiating a radio resource control (RRC) reset operation, releasing a packet data unit (PDU) session associated with a network node, reestablishing the PDU session, initiating a sub-system restart (SSR) associated with the modem, or initiating a reboot of the UE.

In an eleventh aspect, in combination with one or more of the ninth aspect through the tenth aspect, the one or more operations include terminating a particular application executed by the application processor.

In a twelfth aspect, in combination with one or more of the ninth aspect through the eleventh aspect, the method further includes determining, in accordance with one or more ranking criteria, a plurality of ranking values respectively associated with a plurality of applications executed by the application processor. The plurality of applications includes the particular application, and the particular application is terminated in accordance with the plurality of ranking values.

In a thirteenth aspect, in combination with one or more of the ninth aspect through the twelfth aspect, the one or more ranking criteria include, for each application of the plurality of applications, one or more of an idle time associated with the application, a memory utilization associated with the application, or a priority level associated with the application.

In a fourteenth aspect, in combination with one or more of the ninth aspect through the thirteenth aspect, the method further includes detecting one or more conditions indicating that the data stall is associated with the application processor instead of the modem.

In a fifteenth aspect, in combination with one or more of the ninth aspect through the fourteenth aspect, detecting the one or more conditions includes determining that one or more first parameters associated with the modem satisfy one or more modem related criteria.

In a sixteenth aspect, in combination with one or more of the ninth aspect through the fifteenth aspect, detecting the one or more conditions includes determining that one or more second parameters associated with the application processor satisfy one or more application processor related criteria.

In a seventeenth aspect, a non-transitory computer-readable medium stores instructions executable by one or more processors of a user equipment (UE) to receive, at an application processor of the UE from a modem of the UE, an indication of a data stall associated with the UE. The instructions are further executable by the one or more processors to initiate, in accordance with the indication of the data stall, one or more operations associated with a data stall detection and mitigation procedure.

In an eighteenth aspect, in combination with the seventeenth aspect, the one or more operations include one or more of releasing a data interface between the modem and the application processor, reestablishing the data interface, initiating a radio resource control (RRC) reset operation, releasing a packet data unit (PDU) session associated with a network node, reestablishing the PDU session, initiating a sub-system restart (SSR) associated with the modem, or initiating a reboot of the UE.

In a nineteenth aspect, in combination with one or more of the seventeenth aspect through the eighteenth aspect, the one or more operations include terminating a particular application executed by the application processor.

In a twentieth aspect, in combination with one or more of the seventeenth aspect through the nineteenth aspect, the instructions are further executable by the one or more processors to determine, in accordance with one or more ranking criteria, a plurality of ranking values respectively associated with a plurality of applications executed by the application processor. The plurality of applications including the particular application, and the particular application is terminated in accordance with the plurality of ranking values.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (such as application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to the Figures referenced above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

In one or more aspects, the operations described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

The operations of a method or algorithm disclosed herein may be implemented in a processor-executable software module which may reside on a computer-readable medium and commercially made available as a computer program product as software. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc, where disks usually reproduce data magnetically and discs reproduce data optically with lasers. Combinations of the above should also be included within the scope of computer-readable media.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward,” or “left” and “right” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 5, 5, or 50 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. An apparatus for wireless communication by a user equipment (UE), the apparatus comprising:
a processing system including one or more processors and one or more memories coupled to the one or more processors, the one or more processors including an application processor of the UE, the processing system configured to:
receive, at the application processor from a modem of the UE, an indication of a data stall associated with the UE; and
in accordance with the indication of the data stall, initiate one or more operations associated with a data stall detection and mitigation procedure.

2. The apparatus of claim 1, wherein, in accordance with the one or more operations, the processing system is further configured to:
release a data interface between the modem and the application processor;
reestablish the data interface;
initiate a radio resource control (RRC) reset operation;
release a packet data unit (PDU) session associated with a network node;
reestablish the PDU session;
initiate a sub-system restart (SSR) associated with the modem; or
initiate a reboot of the UE.

3. The apparatus of claim 1, wherein, in accordance with the one or more operations, the processing system is further configured to terminate a particular application executed by the application processor.

4. The apparatus of claim 3, wherein the processing system is further configured to determine, in accordance with one or more ranking criteria, a plurality of ranking values respectively associated with a plurality of applications executed by the application processor, the plurality of applications including the particular application, and to terminate the particular application in accordance with the plurality of ranking values.

5. The apparatus of claim 4, wherein the one or more ranking criteria include, for each application of the plurality of applications, one or more of an idle time associated with the application, a memory utilization associated with the application, or a priority level associated with the application.

6. The apparatus of claim 1, wherein the processing system is further configured to detect one or more conditions indicating that the data stall is associated with the application processor instead of the modem.

7. The apparatus of claim 6, wherein the processing system is further configured to detect the one or more conditions in accordance with one or more first parameters associated with the modem satisfying one or more modem related criteria.

8. The apparatus of claim 7, wherein the processing system is further configured to detect the one or more conditions in accordance with one or more second parameters associated with the application processor satisfying one or more application processor related criteria.

9. A method of operation of a user equipment (UE), the method comprising:
receiving, at an application processor of the UE from a modem of the UE, an indication of a data stall associated with the UE; and
in accordance with the indication of the data stall, initiating one or more operations associated with a data stall detection and mitigation procedure.

10. The method of claim 9, wherein the one or more operations include one or more of:
releasing a data interface between the modem and the application processor;
reestablishing the data interface;
initiating a radio resource control (RRC) reset operation;
releasing a packet data unit (PDU) session associated with a network node;
reestablishing the PDU session;
initiating a sub-system restart (SSR) associated with the modem; or
initiating a reboot of the UE.

11. The method of claim 9, wherein the one or more operations include terminating a particular application executed by the application processor.

12. The method of claim 11, further comprising determining, in accordance with one or more ranking criteria, a plurality of ranking values respectively associated with a plurality of applications executed by the application processor, the plurality of applications including the particular application, wherein the particular application is terminated in accordance with the plurality of ranking values.

13. The method of claim 12, wherein the one or more ranking criteria include, for each application of the plurality of applications, one or more of an idle time associated with the application, a memory utilization associated with the application, or a priority level associated with the application.

14. The method of claim 9, further comprising detecting one or more conditions indicating that the data stall is associated with the application processor instead of the modem.

15. The method of claim 14, wherein detecting the one or more conditions includes determining that one or more first parameters associated with the modem satisfy one or more modem related criteria.

16. The method of claim 15, wherein detecting the one or more conditions includes determining that one or more second parameters associated with the application processor satisfy one or more application processor related criteria.

17. A non-transitory computer-readable medium storing instructions executable by one or more processors of a user equipment (UE) to:
receive, at an application processor of the UE from a modem of the UE, an indication of a data stall associated with the UE; and
in accordance with the indication of the data stall, initiate one or more operations associated with a data stall detection and mitigation procedure.

18. The non-transitory computer-readable medium of claim 17, wherein the one or more operations include one or more of:
releasing a data interface between the modem and the application processor;
reestablishing the data interface;
initiating a radio resource control (RRC) reset operation;
releasing a packet data unit (PDU) session associated with a network node;
reestablishing the PDU session;
initiating a sub-system restart (SSR) associated with the modem; or
initiating a reboot of the UE.

19. The non-transitory computer-readable medium of claim 17, wherein the one or more operation includes terminating a particular application executed by the application processor.

20. The non-transitory computer-readable medium of claim 19, wherein the instructions are further executable by the one or more processors to determine, in accordance with one or more ranking criteria, a plurality of ranking values respectively associated with a plurality of applications executed by the application processor, the plurality of applications including the particular application, and wherein the particular application is terminated in accordance with the plurality of ranking values.
